(19) United States
(12) Patent Application Publication
(10) Pub. No.: US 2017/0276000 A1
(43) Pub. Date: Sep. 28, 2017

(54) APPARATUS AND METHOD FOR FORMING APPARATUS

(71) Applicant: GENERAL ELECTRIC COMPANY, Schenectady, NY (US)

(72) Inventors: Zachary John SNIDER, Simpsonville, SC (US); John McConnell DELVAUX, Fountain Inn, SC (US); Glenn Curtis TAXACHER, Simpsonville, SC (US)

(21) Appl. No.: 15/079,346

(22) Filed: Mar. 24, 2016

(51) Int. Cl. F01D 9/02; F01D 11/00

(52) U.S. Cl. CPC F01D 9/02; F01D 11/005; F05D 2300/6033; F05D 2300/614; F05D 2240/11; F05D 2240/128; F05D 2240/30; F05D 2240/55; F05D 2230/60

(57) ABSTRACT

An apparatus is disclosed including a first article, a second article, and a third article disposed adjacent to one another, with the first article and the second article disposed between the third article and a gas path. The first article includes at least one first ceramic matrix composite ply defining a first cooperating feature. The second article includes at least one second ceramic matrix composite ply defining a second cooperating feature. The first cooperating feature and the second cooperating feature define a restricted flow path from the gas path to the third article, which includes a reduced volumetric flow rate of a gas from the gas path to the third article relative to a non-restricted flow path of a non-cooperating interface. A method for forming the apparatus includes forming and aligning the first cooperating feature and the second cooperating feature.

### FIELD OF THE INVENTION

The present invention is directed to apparatuses and methods for forming apparatuses. More particularly, the present invention is directed to apparatuses including cooperating articles which inhibit leakage from a gas path and methods for forming apparatuses including cooperating articles which inhibit leakage from a gas path.

### BACKGROUND OF THE INVENTION

In gas turbines, certain components, such as the shroud surrounding the rotating components in the gas path of the turbine (sometimes referred to as a hot gas path due to the elevated temperatures of the gas traveling through the path), are subjected to extreme temperatures, chemical environments and physical conditions. In particular, the hot gas traveling through the gas path may degrade materials which are otherwise desirable due to qualities such as their low cost and high reparability.

Various designs and techniques are utilized to isolate the hot gas of the gas path from components which are susceptible to such degradation. By way of example, shrouds are often constructed in two primary components, an inner shroud which is adjacent to the gas path and which is made from materials which are resistant to the effects of the hot gas, and an outer shroud which is largely isolated from the hot gas, and which may therefore be constructed of less durable materials which have other desirable qualities.

However, inner shrouds are typically arranged with a series of shroud segments which abut one another. Each interface provides an opportunity for hot gas to leak through the barrier provided by the inner shroud and contact the outer shroud, potentially degrading the outer shroud. One method of limiting this leakage of hot gas is to insert a seal, such as a laminate seal, into the interface. Such seals may be unsuitable, however, for regions of the shroud where the inner shroud is too thin for a laminate seal to be inserted, or too curved for a laminate seal to be inserted, or both.

### BRIEF DESCRIPTION OF THE INVENTION

In an exemplary embodiment, an apparatus includes a first article, a second article and a third article. The first article includes at least one first ceramic matrix composite ply, and is adjacent to a gas path. The second article includes at least one second ceramic matrix composite ply, and is adjacent to the gas path and the first article. The third article is adjacent to the first article and the second article, with the first article and the second article being disposed between the third article and the gas path. The at least one first ceramic matrix composite ply and the at least one second ceramic matrix composite ply define an interface including a first cooperating feature of the at least one first ceramic matrix composite ply and a second cooperating feature of the at least one second ceramic matrix composite ply. The first cooperating feature and the second cooperating feature define a restricted flow path from the gas path to the third article. The restricted flow path includes a reduced volumetric flow rate of a gas from the gas path to the third article relative to a non-restricted flow path of a non-cooperating interface.

In another exemplary embodiment, a method for forming an apparatus includes forming a first cooperating feature into at least one first ceramic matrix composite ply of a first article, forming a second cooperating feature into at least one second ceramic matrix composite ply of a second article, and positioning the first article adjacent to the second article, and the first article and the second article adjacent to a third article. The first article, second article, and third article are arranged and configured such that the first article and the second article are disposed between the third article and a gas path. The first cooperating feature is aligned with the second cooperating feature to define an interface having a restricted flow path from the gas path to the third article. The restricted flow path includes a reduced volumetric flow rate of a gas from the gas path to the third article relative to a non-restricted flow path of a non-cooperating interface.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of an apparatus, according to an embodiment of the disclosure.

FIG. 2 is an expanded exploded view of a portion of the apparatus of FIG. 1, according to an embodiment of the disclosure.

FIG. 3 is a cross section view of the interface between the first article and the second article of FIG. 1 along line 3-3, according to an embodiment of the disclosure.

FIG. 4 is a cross section view of the interface between the first article and the second article of FIG. 1 along line 4-4, according to an embodiment of the disclosure.

FIG. 5 is a cross section view of the interface between the first article and the second article of FIG. 1 along line 5-5, according to an embodiment of the disclosure.

FIG. 6 is a cross section view of a non-cooperating interface otherwise comparable to the interface between the first article and the second article of FIG. 1, for comparative purposes.

Wherever possible, the same reference numbers will be used throughout the drawings to represent the same parts.

### DETAILED DESCRIPTION OF THE INVENTION

Provided is an article such as, but not limited to, a turbine component. Embodiments of the present disclosure, for example, in comparison to concepts failing to include one or more of the features disclosed herein, increase efficiency, increase durability, increase temperature tolerance, reduce overall cost reduce material cost, reduce the need for pressurizing a shroud or similar turbine component, increase required service intervals, produce other advantages, or a combination thereof.

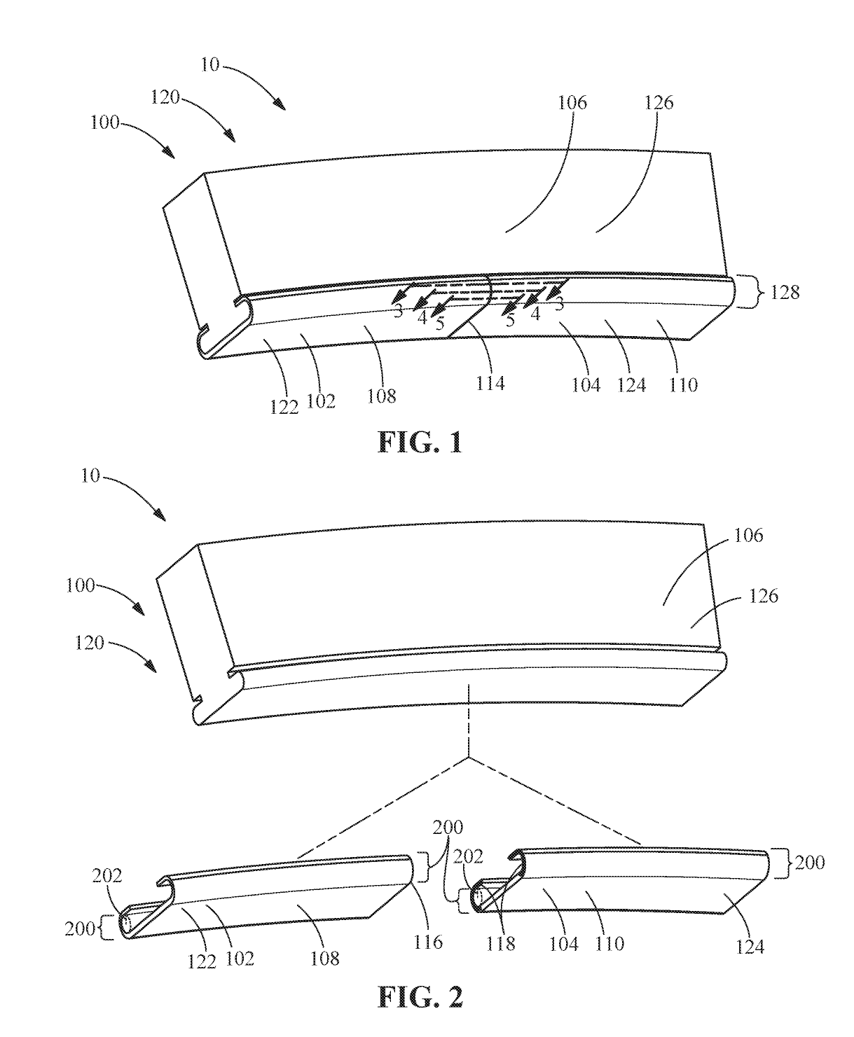

Referring to FIGS. 1 and 2, in one embodiment, an apparatus 10 includes a first article 102, a second article 104, and a third article 106. The first article 102 includes at least one first ceramic matrix composite ply 108, and is adjacent to a gas path 112 (not shown). The second article 104 includes at least one second ceramic matrix composite ply 110, and is adjacent to the gas path 112 and the first article 102. The third article 106 is adjacent to the first article 102 and the second article 104, with the first article 102 and the second article 104 being disposed between the third article 106 and the gas path 112. The at least one first ceramic matrix composite ply 108 and the at least one second ceramic matrix composite ply 110 define an interface 114. The apparatus 10 may be any suitable apparatus, including, but not limited to, a turbine component 100.

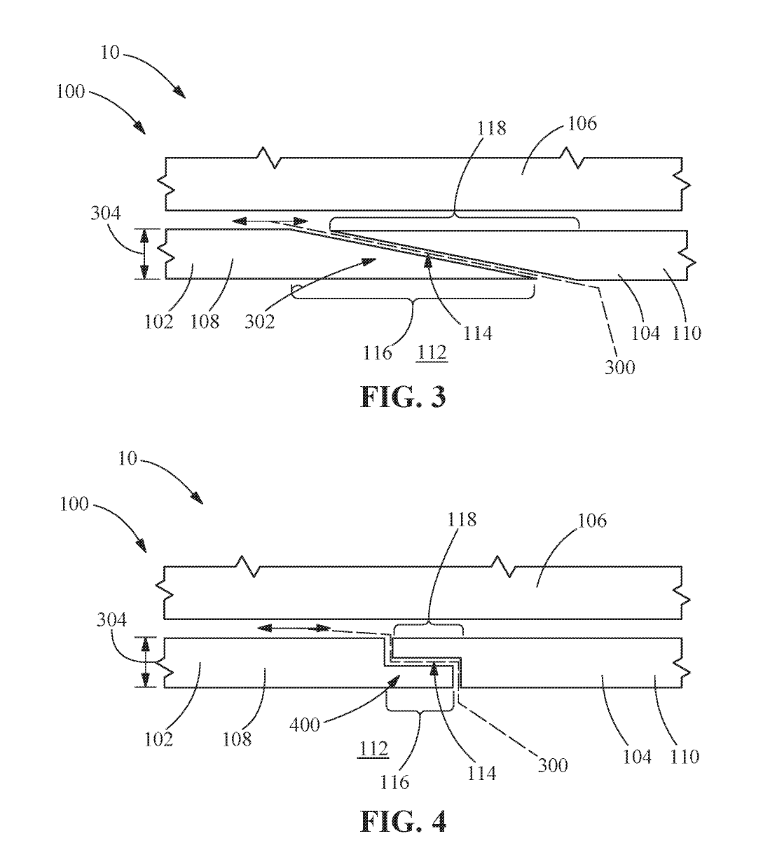

Referring to FIGS. 3-6, the interface 114 includes a first cooperating feature 116 of the at least one first ceramic matrix composite ply 108 and a second cooperating feature 118 of the at least one second ceramic matrix composite ply 110. The first cooperating feature 116 and the second cooperating feature 118 define a restricted flow path from the gas path 112 to the third article. The restricted flow path 300 includes a reduced volumetric flow rate of a gas from the gas path 112 to the third article 106 relative to a non-restricted flow path 600 of a non-cooperating interface 602.

In one embodiment, the at least one first ceramic matrix composite ply 108 consists of a single ply. In another embodiment, the at least one first ceramic matrix composite ply 108 includes a plurality of plies. In one embodiment, the at least one second ceramic matrix composite ply 110 consists of a single ply. In yet another embodiment, the at least one second ceramic matrix composite ply 110 includes a plurality of plies.

Referring again to FIG. 1, the article 10 may be any suitable turbine component 100, including, but not limited to, a shroud (shown), a turbine blade (bucket) shroud, a near flowpath seal, or a nozzle (vane) endwall. In one embodiment, wherein the turbine component 100 is a shroud, the first article 102 is a first inner shroud segment, the second article 104 is a second inner shroud segment, and the third article 106 is an outer shroud. In a further embodiment, the interface 114 is a hook segment 128 of the shroud 120.

The at least one first ceramic matrix composite ply 108 and the at least one second ceramic matrix composite ply 110 may independently include any suitable ceramic matrix composite composition, including, but not limited to, a ceramic matrix composite including reinforcing fibers wherein the reinforcing fibers may include, but are not limited to, silicon fibers, carbon fibers, silicon carbide fibers, SCS-6 silicon carbine monofilament fibers, rare-earth silicate fibers, silicon nitride fibers, aluminum oxide fibers, silica fibers, boron fibers, boron carbide fibers, aramid fibers, para-aramid fibers, KEVLAR™ para-aramid fibers, refractory metal fibers, superalloy fibers, silica-alumina-magnesia fibers, S-glass fibers, zirconium fibers, beryllium fibers, or a combination thereof, an aluminum oxide-fiber-reinforced aluminum oxide (Ox/Ox), a carbon-fiber-reinforced carbon (C/C), a carbon-fiber-reinforced silicon carbide (C/SiC), a silicon-carbide-fiber-reinforced silicon carbide (SiC/SiC), or a combination thereof.

The third article 106 may include any suitable composition such as, but not limited to, a metallic composition. Suitable metallic compositions include, but are not limited to, a titanium alloy, an aluminum alloy, an aluminum-titanium-based alloy, a steel, a stainless steel, a nickel-based superalloy, an alloy suitable for turbine applications, or a combination thereof.

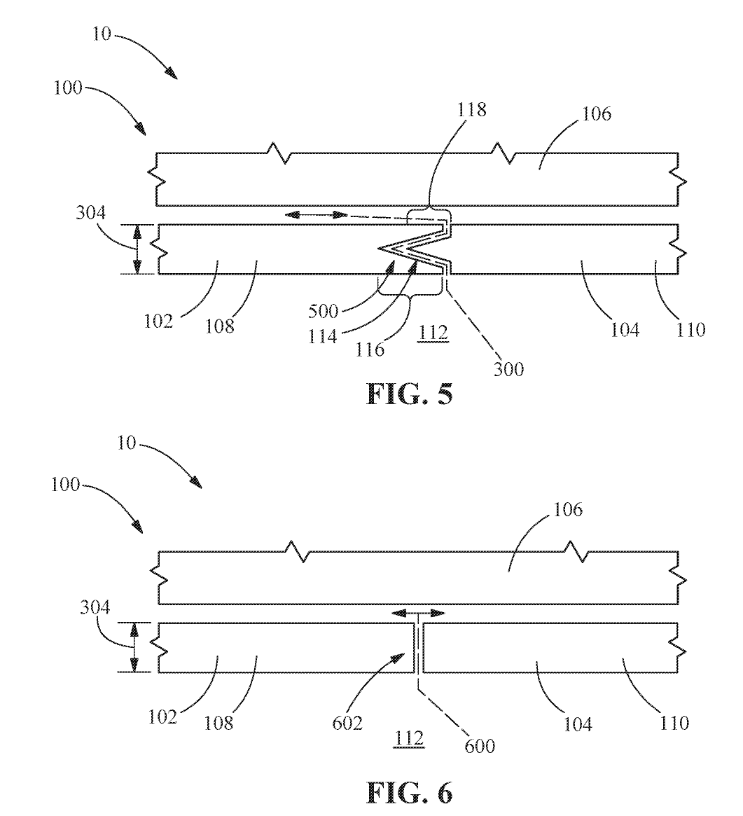

The interface 114 may be any suitable interface which establishes restricted flow path 300. Suitable interfaces 114 may include, but are not limited to, a bridle interface, a finger interface, a dovetail interface, a dada interface, a groove interface, a tongue and groove interface, a triangular tongue and groove interface, a mortise and tenon interface, a hammer-headed tenon interface, a scarf interface 302. (shown in FIG. 3), a plane scarf interface, a nibbed scarf interface, a splice interface, a half lap splice interface 400 (shown in FIG. 4), a bevel lap splice interface, a tabled splice interface, a tapered finger splice interface, a sawtooth interface, a chevron interface 500 (shown in FIG. 5), a sinusoidal interface, or a combination thereof.

The interface 114 includes a thickness 304. The thickness 304 of the interface 114 may be any suitable thickness 304, including, but not limited to, a thickness 304 of at least about 0.045 inches, alternatively at least about 0.06 inches, alternatively at least about 0.075 inches, alternatively less than about 0.4 inches, alternatively less than about 0.35 inches, alternatively less than about 0.3 inches, alternatively less than about 0.25 inches, alternatively less than about 0.2 inches, alternatively less than about 0.15 inches, alternatively less than about 0.1 inches, alternatively between about 0.045 inches to about 0.4 inches, alternatively between about 0.045 inches to about 0.3 inches, alternatively between about 0.045 inches to about 0.2 inches, alternatively between about 0.045 inches to about 0.1 inches.

Referring again to FIG. 2, in one embodiment, the interface 114 includes a curved portion 200 having a curvature of at least about 45°, alternatively at least about 60°, alternatively at least about 75°, alternatively at least about 90°, alternatively at least about 105°, alternatively at least about 120°, alternatively at least about 180°, alternatively at least about 195°. The curved portion 200 includes a radius of curvature 202. The radius of curvature 202 may be any suitable radius, measured at a mean thickness along the curved portion 200, including, but not limited to, a radius of less than about 0.5 inches, alternatively less than about 0.4 inches, alternatively less than about 0.3 inches, alternatively less than about 0.25 inches, alternatively less than about 0.2 inches, alternatively less than about 0.15 inches, alternatively less than about 0.1 inches.

Referring to FIGS. 2 and 3-5, in one embodiment, incorporation of the first cooperating feature 116 and the second cooperative feature 118 to form the interface 114 is operative to restrict flow from the gas path 112 to the third article 106 wherein the interface 114 includes a curved portion 200 having at least one of a curvature which is too severe and radius of curvature 202 which is too small, in combination with a thickness 304 (as shown in FIG. 3) which is too narrow, for a laminate seal to be inserted into the interface 114 and be effective in restricting flow from the gas path 112 to the third article 106.

Referring to FIGS. 1-5, in one embodiment a method for forming the article 10 includes forming the first cooperating feature 116 into the at least one first ceramic matrix composite ply 108 of the first article 102, and forming the second cooperating feature 118 into the at least one second ceramic matrix composite ply 110 of the second article 104. The first article 102 is positioned adjacent to the second article 104, and the first article 102 and the second article 104 are positioned adjacent to the third article 106. The first article 102, second article 104, and third article 106 are arranged and configured such that the first article 102 and the second article 104 are disposed between the third article 106 and a gas path 112. The first cooperating feature 116 is aligned with the second cooperating feature 118 to define the interface 114 having the restricted flow path 300 from the gas path 112 to the third article 106.

Forming the first cooperating feature 116 and the second cooperating feature 118 may include any suitable technique. In one embodiment, the first cooperating feature 116 is formed in the at least one first ceramic matrix composite ply 108 and the second cooperating feature 118 is formed in the at least one second ceramic matrix composite ply 110, wherein the at least one first ceramic matrix composite ply 108 and the at least one second ceramic matrix composite ply 110 are separate and distinct from one another when the first cooperating feature 116 and the second cooperating features 118 are formed. In another embodiment, at least one ceramic matrix composite ply is separated into the at least one first ceramic matrix composite ply 108 and the at least one second ceramic matrix composite ply 110, wherein separating the at least one first ceramic matrix composite ply 108 from the at least one second ceramic matrix composite ply 110 forms the first cooperating feature 116 and the second cooperating feature 118. Separating the at least one first ceramic matrix composite ply 108 from the at least one second ceramic matrix composite ply 110 may include any suitable severing technique, including, but not limited to cutting, milling, drilling, grinding, abrasive flow machining, abrasive jet machining, laser cutting, plasma cutting, water jet cutting, or a combination thereof.

In one embodiment, forming the first cooperating feature 116 and the second cooperating feature 118 includes at least one of machining the first cooperating feature 116 into the at least one first ceramic matrix composite ply 108 and machining the second cooperating feature 118 into the at least one second ceramic matrix composite ply 110. In a further embodiment, forming the first cooperating feature 116 and the second cooperating feature 118 includes machining the first cooperating feature 116 into the at least one first ceramic matrix composite ply 108 and machining the second cooperating feature 118 into the at least one second ceramic matrix composite ply 110. Machining may include any suitable technique, including, but not limited to, a severing technique, diamond grinding, electrical discharge machining, or a combination thereof.

In another embodiment, forming the first cooperating feature 116 and the second cooperating feature 118 includes at least one of molding the at least one first ceramic matrix composite ply 108 to net shape including the first cooperating feature 116 and molding the at least one second ceramic matrix composite ply 110 to net shape including the second cooperating feature 118. In a further embodiment, forming the first cooperating feature 116 and the second cooperating feature 118 includes molding the at least one first ceramic matrix composite ply 108 to net shape including the first cooperating feature 116 and molding the at least one second ceramic matrix composite ply 110 to net shape including the second cooperating feature 118.

In yet another embodiment, forming the first cooperating feature 116 and the second cooperating feature 118 includes at least one of printing the at least one first ceramic matrix composite ply 108 having the first cooperating feature 116 by a near net shape printing process and printing the at least one second ceramic matrix composite ply 110 having the second cooperating feature 118 by a near net shape printing process. In a further embodiment, forming the first cooperating feature 116 and the second cooperating feature 118 includes printing the at least one first ceramic matrix composite ply 108 having the first cooperating feature 116 by a near net shape printing process and printing the at least one second ceramic matrix composite ply 110 having the second cooperating feature 118 by a near net shape printing process. Printing may include any suitable ceramic matrix composite printing process, including, but not limited to extruding a coated pre-impregnated tow by a continuous filament fabrication process. In one embodiment, printing includes placing and orienting reinforcing fibers and from a fiber feeding print head. In a further embodiment, the fiber feeding print head is mounted on a gantry.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus, comprising:
a first article including at least one first ceramic matrix composite ply, the first article being adjacent to a gas path;
a second article including at least one second ceramic matrix composite ply, the second article being adjacent to the gas path and the first article; and
a third article, the third article being adjacent to the first article and the second article, the first article and the second article being disposed between the third article and the gas path,
wherein the at least one first ceramic matrix composite ply and the at least one second ceramic matrix composite ply define an interface, the interface including a first cooperating feature of the at least one first ceramic matrix composite ply and a. second cooperating feature of the at least one second ceramic matrix composite ply, the first cooperating feature and the second cooperating feature defining a restricted flow path from the gas path to the third article, the restricted flow path including a reduced volumetric flow rate of a gas from the gas path to the third article relative to a non-restricted flow path of a non-cooperating interface.

2. The apparatus of claim 1, wherein the apparatus is a turbine component.

3. The apparatus of claim 2, wherein the turbine component is a shroud, the first article is a first inner shroud segment, the second article is a second inner shroud segment, and the third article is an outer shroud.

4. The apparatus of claim 3, wherein the interface is a hook segment of the shroud.

5. The apparatus of claim 1, wherein the at least one first ceramic matrix composite ply and the at least one second ceramic matrix composite ply independently include a ceramic matrix composite composition selected from the group consisting of:
an aluminum oxide-fiber-reinforced aluminum oxide (Ox/Ox);
a carbon-fiber-reinforced carbon (C/C);
a carbon-fiber-reinforced silicon carbide (C/SiC);
a silicon-carbide-fiber-reinforced silicon carbide (SiC/SiC);
a ceramic matrix composite including reinforcing fibers selected from the group consisting of silicon fibers, carbon fibers, silicon carbide fibers, SCS-6 silicon carbine monofilament fibers, rare-earth silicate fibers, silicon nitride fibers, aluminum oxide fibers, silica fibers, boron fibers, boron carbide fibers, aramid fibers, para-aramid fibers, KEVLAR™ para-aramid fibers, refractory metal fibers, superalloy fibers, silica-alumina-magnesia fibers, S-glass fibers, zirconium fibers, beryllium fibers, and combinations thereof; and
combinations thereof.

6. The apparatus of claim 1, wherein the third article includes a metallic composition.

7. The apparatus of claim 1, wherein the interface is selected from the group consisting of a bridle interface, a finger interface, a dovetail interface, a dada interface, a groove interface, a tongue and groove interface, a triangular tongue and groove interface, a mortise and tenon interface, a hammer-headed tenon interface, a scarf interface, a plane scarf interface, a nibbed scarf interface, a splice interface, a half lap splice interface, a bevel lap splice interface, a tabled splice interface, a tapered finger splice interface, a sawtooth interface, a chevron interface, a sinusoidal interface, and combinations thereof.

8. The apparatus of claim 1, wherein the interface includes a thickness of between about 0.045 inches to about 0.4 inches.

9. The apparatus of claim 1, wherein the interface includes a curved portion having a curvature of at least about 45°.

10. The apparatus of claim 9, wherein the curved portion includes a radius of curvature of less than about 0.5 inches, measured at a mean thickness along the curved portion.

11. A method for forming an apparatus, comprising:
forming a first cooperating feature into at least one first ceramic matrix composite ply of a first article;
forming a second cooperating feature into at least one second ceramic matrix composite ply of a second article;
positioning the first article adjacent to the second article, and the first article and the second article adjacent to a third article, arranged and configured such that the first article and the second article are disposed between the third article and a gas path;
aligning the first cooperating feature with the second cooperating feature to define an interface having a restricted flow path from the gas path to the third article, the restricted flow path including a reduced volumetric flow rate of a gas from the gas path to the third article relative to a non-restricted flow path of a non-cooperating interface.

12. The method of claim 11, wherein forming the article includes forming a turbine shroud as the article, positioning a first inner shroud segment as the first article, positioning a second inner shroud segment as the second article, and positioning an outer shroud as the third article.

13. The method of claim 12, wherein defining the interface includes defining a hook segment of the shroud.

14. The method of claim 11, wherein defining the interface includes defining the interface selected from the group consisting of a bridle interface, a finger interface, a dovetail interface, a dado interface, a groove interface, a tongue and groove interface, a triangular tongue and groove interface, a mortise and tenon interface, a hammer-headed tenon interface, a scarf interface, a plane scarf interface, a nibbed scarf interface, a splice interface, a half lap splice interface, a bevel lap splice interface, a tabled splice interface, a tapered finger splice interface, a sawtooth interface, a chevron interface, a sinusoidal interface, and combinations thereof.

15. The method of claim 11, wherein at least one of forming the first cooperating feature and forming the second cooperating feature includes at least one of machining the first cooperating feature into the at least one first ceramic matrix composite ply and machining the second cooperating feature into the at least one second ceramic matrix composite ply.

16. The method of claim 11, wherein at least one of forming the first cooperating feature and forming the second cooperating feature includes at least one of molding the at least one first ceramic matrix composite ply to net shape including the first cooperating feature and molding the at least one second ceramic matrix composite ply to net shape including the second cooperating feature.

17. The method of claim 11, wherein at least one of forming the first cooperating feature and forming the second cooperating feature includes at least one of printing the at least one first ceramic matrix composite ply having the first cooperating feature by a near net shape printing process and printing the at least one second ceramic matrix composite ply having the second cooperating feature by a near net shape printing process.

18. The method of claim 11, wherein defining the interface includes the interface having a thickness of between about 0.045 inches to about 0.4 inches.

19. The method of claim 11, wherein defining the interface includes the interface having a curved portion having a curvature of at least about 45°.

20. The method of claim 19, wherein defining the interface includes the interface having a radius of curvature of less than about 0.5 inches, measured at a mean thickness along the curved portion.
